(19) United States
(12) Patent Application Publication
(10) Pub. No.: US 2023/0193518 A1
(43) Pub. Date: Jun. 22, 2023

(54) ULTRA-FINE DENIER UHMW PE FIBER

(71) Applicant: HONEYWELL INTERNATIONAL INC., CHARLOTTE, NC (US)

(72) Inventors: MARK BENJAMIN BOONE, MECHANICSVILLE, VA (US); JOHN HERMES, COLONIAL HEIGHTS, VA (US)

(73) Assignee: HONEYWELL INTERNATIONAL INC., CHARLOTTE, NC (US)

(21) Appl. No.: 18/064,623

(22) Filed: Dec. 12, 2022

Related U.S. Application Data
(60) Provisional application No. 63/291,308, filed on Dec. 17, 2021.

(51) Int. Cl. D01F 6/04; D04H 1/70; D04H 3/115; C08L 23/06

(52) U.S. Cl. CPC D01F 6/04; D04H 1/70; D04H 3/115; C08L 23/06; D10B 2321/021

(57) ABSTRACT

Polyethylene compositions and finish-free, ultra-fine denier, ultra-high molecular weight polyethylene (UHMW PE) fibers and tapes are provided. The fibers and tapes are made from said compositions that are usable in medical, in-body applications, as well as a process of their making.

### CROSS-REFERENCE TO RELATED APPLICATION

This application claims the benefit of co-pending U.S. Provisional Application Ser. No. 63/291,308, filed on Dec. 17, 2021, the disclosure of which is incorporated by reference herein in its entirety.

### BACKGROUND

### TECHNICAL FIELD

The disclosure relates to improved polyethylene compositions and finish-free, ultra-fine denier, ultra-high molecular weight polyethylene (UHMW PE) fibers and tapes made from said compositions that are usable in medical, in-body applications, as well as a process of their making.

### DESCRIPTION OF THE RELEATED ART

Multi-filament polyolefin fibers have been produced possessing high tensile properties such as tenacity and tensile modulus. It is conventionally known that such fibers are useful in applications requiring impact absorption and ballistic resistance such as body armor and sports equipment such as kayaks, boats, fishing lines and ropes. Such high-strength polyolefin fibers can also be used in medical in-body applications, such as for sutures in cardiovascular and orthopedic surgery. For cardiovascular applications it is desirable for the fibers to be as thin as practical and gel-spun ultra-high molecular weight polyethylene fibers can provide desired high strength in combination with a very fine diameter (low denier). While high-strength UHMW PE fibers have been commercially available for decades, ultra-fine denier fibers have only been available more recently and commercial processes used to make heavier denier UHMW PE fibers are not practical for making ultra-fine denier fibers.

Ultra-high molecular weight polyolefins include polyethylenes having a molecular weight of at least about 500,000 g/mol. However, it should be understood that all references herein to the term “ultra-high” with regard to the molecular weight of the polyolefins or polyethylenes of this disclosure is not intended to be limiting at the maximum end of polymer viscosity and/or polymer molecular weight. The term “ultra-high” is only intended to be limiting at the minimum end of polymer viscosity and/or polymer molecular weight to the extent that useful polymers within the scope of the disclosure are capable of being processed into fibers. It should also be understood that while the processes described herein are most preferably applied to the processing of UHMW polyethylene, they are equally applicable to all other poly(alpha-olefins), i.e. UHMW PO polymers, including polypropylene and other types of polyethylenes, e.g., low density, medium density and high density polyethylenes.

Many different techniques are known for the fabrication of high tenacity filaments and fibers formed from such ultra-high molecular weight polyethylene polymers. For example, high tenacity polyethylene fibers may be made by spinning a solution containing ultra-high molecular weight polyethylene. Ultra-high molecular weight polyethylene particles are mixed with a suitable solvent, whereby the particles are swelled with and dissolved by the solvent to form a solution. The solution is then extruded through a spinneret to form solution filaments, followed by cooling the solution filaments to a gel state to form gel filaments, then removing the spinning solvent to form solvent-free (or substantially solvent-free) filaments. One or more of the solution filaments, the gel filaments and the solvent-free filaments are stretched or drawn to a highly oriented state in one or more stages to enhance their tensile properties. In general, such filaments are known as “gel-spun” polyethylene filaments. Multi-filament, gel-spun ultra-high molecular weight polyethylene fibers are produced, for example, by Honeywell International Inc. of Charlotte, N.C.

Various methods for forming gel-spun polyethylene filaments have been described, for example, in U.S. Pat. Nos. 4,413,110; 4,536,536; 4,551,296; 4,663,101; 5,006,390; 5,032,338; 5,578,374; 5,736,244; 5,741,451; 5,958,582; 5,972,498; 6,448,359; 6,746,975; 6,969,553; 7,078,099; 7,344,668; 7,846,363; 8,361,366; 8,444,898; 8,506,864; 8,747,715; 8,889,049; 9,169,581; 9,365,953 and 9,556,537, all of which are incorporated herein by reference to the extent consistent herewith. For example, U.S. Pat. Nos. 4,413,110, 4,663,101 and 5,736,244 describe the formation polyethylene gel precursors and the stretching of low porosity xerogels obtained therefrom to form high tenacity, high modulus fibers. U.S. Pat. Nos. 5,578,374 and 5,741,451 describe post-stretching a polyethylene fiber which has already been oriented by drawing at a particular temperature and draw rate. U.S. Pat. No. 6,746,975 describes high tenacity, high modulus multifilament yarns formed from polyethylene solutions via extrusion through a multi-orifice spinneret into a cross-flow gas stream to form a fluid product. The fluid product is gelled, stretched and formed into a xerogel. The xerogel is then subjected to a dual stage stretch to form the desired multifilament yarns. U.S. Pat. No. 7,078,099 describes drawn, gel-spun multifilament polyethylene yarns having increased perfection of molecular structure. The yarns are produced by an improved manufacturing process and are drawn under specialized conditions to achieve multifilament yarns having a high degree of molecular and crystalline order. U.S. Pat. No. 7,344,668 describes a process for drawing essentially diluent-free gel-spun polyethylene multifilament yarns in a forced convection air oven and the drawn yarns produced thereby. The process conditions of draw ratio, stretch rate, residence time, oven length and feed speed are selected in specific relation to one another so as to achieve enhanced efficiency and productivity. Finally, U.S. Pat. No. 8,444,898 describes a process for the continuous preparation of solutions of ultra-high molecular weight polyethylene having improved homogeneity that produces strong materials at high production capacity.

While each of the above fiber manufacturing processes are suitable for the fabrication of multifilament UHMW PE fibers, each process utilizes a manufacturing process that is non-ideal for producing fibers intended for use in human medical applications. For such medical, in-body applications, biocompatibility is an important factor for the use of a fiber. However, gel spinning solvents that are used in typical fiber gel spinning processes like those described above are often toxic to humans and are not suitable for use in-vivo. In processes such as those described above, it is known to remove the spinning solvent from the fiber as part of the complete spinning process. However, the solvents are typically ozone depleting and thus are an environmental hazard, so great care must be taken when extracting or evaporating the solvent from the fiber and also when subsequently recycling or disposing of the solvent. Accordingly, there is a need in the art for an improved gel spinning process that utilizes a solvent that is more environmentally acceptable and non-toxic to humans and animals.

In addition, as described in the patents referenced above, it is conventionally known that spin finishes, which are surface finishes typically applied to fibers during manufacturing, are generally not biocompatible or are toxic to mammals. As a result, spin finishes must be removed from the fibers such as by washing or extracting before they can be used in medical applications. This adds additional complexity and cost to the fiber manufacturing process. Accordingly, a fiber manufacturing process that does not require the use of a spin finish is desired in the art. This disclosure provides a solution to both these needs in the art.

### SUMMARY OF THE DISCLOSURE

This disclosure provides compositions and articles comprising mixtures of polyethylene and trimethylbenzene (“TMB”), which is a highly effective solvent for polyethylene, particularly at elevated mixture temperatures. Trimethylbenzene is a lower health hazard to both mammals and to the environment compared to other solvents, and its effectiveness as a solvent for polyethylene and its volatility allows for improvements in the fiber manufacturing process that achieve highly pure fibers, i.e., fibers having ultra-low residual solvent content and that do not require the use of a spin-finish to be effectively processed. The spin finish can be avoided because polyethylene gels formed with a trimethylbenzene solvent have been found to be of a very high quality, which allows for the gel spinning of filaments having very high tensile strengths at exceedingly small filament deniers without requiring substantial in-line drawing of the filaments during the fabrication process to achieve such high tensile strength, as is conventional in the art. Instead, most or all of the filament drawing is conducted in an off-line, post-drawing operation. Eliminating most or all of the in-line drawing allows for the manufacture of fibers at lower line speeds and allows for the application of maintained, uniform, high fiber tension along the full length of the fiber line. This effectively avoids static buildup during manufacture so that no spin finish is otherwise needed to counteract static buildup. This is important because spin finishes can be toxic to mammals and fibers with a finish cannot be used in vivo. The potential for static build-up and tangling are minimal in the off-line, post-drawing operation. The volatility of trimethylbenzene also allows for it to be evaporated from the filaments without need for extraction with a second solvent, and the ultra-fine filament deniers achievable with this process allows for more rapid and efficient solvent evaporation due to the higher surface area to volume ratio of the filaments. As a result, the fibers are suitable for use in mammals in-vivo and are manufactured with greater commercial efficiency and environmental safety.

Particularly, the disclosure provides a composition comprising a mixture of polyethylene and trimethylbenzene.

The disclosure also provides a process for preparing a polyethylene fiber product comprising:

a) forming a solution of polyethylene in a trimethylbenzene solvent, wherein said polyethylene has a weight average molecular weight of at least 500,000 g/mol;

b) spinning the solution through a spinneret to form one or more solution filaments;

c) cooling the solution filaments wherein said one or more solution filaments are converted into gel filaments, wherein said gel filaments comprise greater than 1% solvent by weight of the polyethylene plus the solvent; and
d) evaporating the solvent from the gel filaments to form dried filaments, wherein the evaporation continues until the solvent concentration in the dried filament is less than 1% by weight of the polyethylene plus the solvent.

### BRIEF DESCRIPTION OF THE DRAWINGS

FIG. 1 is a side perspective view schematic representation of a process of forming and drawing a fiber without applying a spin finish.

### DETAILED DESCRIPTION

The polyethylene-trimethylbenzene compositions provided herein are particularly intended for the fabrication of high strength, medical grade fibers that can be used in-vivo inside the bodies of humans and animals, but that intended end use is not intended to be strictly limiting and the compositions may be used in the fabrication of fibers for any other end use, including composites and composite armor, as well as any other non-fibrous, non-armor application as may be desired.

As used herein, a “fiber” is a long strand of a material, such as a strand of a polymeric material, the length dimension of which is much greater than the transverse dimensions of width and thickness. The fiber is preferably a long, continuous (but of a definite length) strand, as distinguished from a short segment of a strand referred to in the art as a “staple” or “staple fiber.” A “strand” by its ordinary definition is an elongate body such as a thread or fiber. The cross-sections of fibers for use herein may vary widely, and they may be circular, flat or oblong in cross-section. They also may be of irregular or regular multi-lobal cross-section having one or more regular or irregular lobes projecting from the linear or longitudinal axis of the filament. Thus the term “fiber” includes filaments, ribbons, strips and the like having regular or irregular cross-section. It is preferred that the fibers have a substantially circular cross-section.

A single fiber may be formed from just one filament or from multiple filaments. A fiber formed from just one filament is referred to herein as either a “single-filament” fiber or a “monofilament” fiber, and a fiber formed from a plurality of filaments is referred to herein as a “multifilament” fiber. Multifilament fibers as defined herein preferably include from 2 to about 3000 filaments, more preferably from 2 to 500 filaments, still more preferably from 4 to 500 filaments, still more preferably from 6 to 500 filaments, still more preferably from about 6 filaments to about 250 filaments and most preferably from about 6 to about 125 filaments. Multifilament fibers are also often referred to in the art as fiber bundles or a bundle of filaments. As used herein, the term “yarn” is defined as a single strand consisting of multiple filaments and is used interchangeably with “multifilament fiber.” The filaments forming a yarn are typically twisted together.

It is generally known that very high strength filaments and fibers having superior tensile properties are made by a process known as “gel spinning,” also referred to as “solution spinning,” including gel/solution spinning of ultra-high molecular weight polyolefins (UHMW PO), and in particular ultra-high molecular weight polyethylene (UHMW PE). This method is used for fabricating high strength polyolefins because the high molecular weight, and the corresponding high polymer intrinsic viscosity, make traditional polymer extrusion techniques difficult for the fabrication of very thin filaments/fibers. In a conventional gel spinning process, a solution of polyethylene and a spinning solvent is formed followed by extruding the solution through a multi-orifice spinneret to form solution filaments, cooling the solution filaments into gel filaments, and then evaporating or extracting the solvent to form solid, dry (or substantially dry) filaments. These dry filaments are grouped into bundles which are referred to in the art as either fibers or yarns. The fibers/yarns are then typically stretched (drawn) up to a maximum drawing capacity to increase their tenacity, with at least one of the solution filaments, gel filaments and dry filaments being stretched. In the present process of forming polyethylene fibers, the polyethylene-solvent solutions are generally formed according to the following sequence of steps:

1) The formation of a slurry, i.e., a dispersion (or suspension) of solid polyethylene polymer particles (such as UHMW PE particles) in a solvent that is capable of dissolving the polymer;

2) Heating the slurry to melt the polymer and to form a liquid mixture under conditions of intense distributive and dispersive mixing to thereby reduce the domain sizes of molten polymer and solvent in the mixture to microscopic dimensions; and

3) Allowing sufficient time for diffusion of the solvent into the polymer and of the polymer into the solvent to occur to thereby form a solution.

The particle size and particle size distribution of the particulate polyethylene polymer can affect the extent to which the polyethylene polymer dissolves in the spinning solvent during formation of the solution that is to be gel spun. It is also desirable that the polyethylene polymer be completely dissolved in the solution and sufficiently mixed so that the solution is most preferably homogenous. Accordingly, in one preferred example, polyethylene particles are provided that have an average particle size of from about 100 microns (μm) to about 200 μm. In such an example, it is preferred that up to about, or at least about 90% of the polyethylene particles have a particle size that is within 40 μm of the average polyethylene particle size. In other words, up to about, or at least about 90% of the polyethylene particles have a particle size that is equal to the average particle size plus or minus 40 μm. In another example, about 75% by weight to about 100% by weight of the polyethylene particles utilized can have a particle size of from about 100 μm to about 400 μm, and preferably about 85% by weight to about 100% by weight of the polyethylene particles have a particle size of from about 120 μm to 350 μm. Additionally, the particle size can be distributed in a substantially Gaussian curve of particle sizes centered at about 125 to 200 μm. It is also preferred that about 75% by weight to about 100% by weight of the polyethylene particles utilized are UHMW PE particles having a weight average molecular weight of from about 500,000 to about 7,000,000, more preferably from about 700,000 to about 5,000,000. Preferably, the UHMW PE starting material has a ratio of weight average molecular weight to number average molecular weight (M_{w}/Mₙ) of 6 or less, more preferably, 5 or less, still more preferably 4 or less, still more preferably 3 or less, still more preferably 2 or less, and even more preferably an M_{w}/Mₙ, ratio of about 1.

Preferably, the polyethylene is a UHMW PE polymer starting material having fewer than about 5 side groups per 1000 carbon atoms, more preferably fewer than about 2 side groups per 1000 carbon atoms, yet more preferably fewer than about 1 side group per 1000 carbon atoms, and most preferably fewer than about 0.5 side groups per 1000 carbon atoms. Side groups may include but are not limited to C₁-C₁₀ alkyl groups, vinyl terminated alkyl groups, norbornene, halogen atoms, carbonyl, hydroxyl, epoxide and carboxyl.

The polyethylene polymer, or the mixture of polyethylene and the solvent (the slurry or liquid mixture or the solution), may contain small amounts, generally less than about 5 wt. %, preferably about 1 wt. % or less of additives such as antioxidants, thermal stabilizers, colorants, flow promoters, solvents, etc. Small amounts of other additives may also be optionally added to the mix of polymer and solvent. For example, a processing aid such as mineral oil may be added in a small amount (from about 1,000 PPM to about 9,000 PPM) as may be desirable.

In general, higher fiber tensile properties are obtained from polymers having higher intrinsic viscosities. The intrinsic viscosity of a polymer is a measure of the molecular weight of the polymer. In this regard, a UHMW PE polymer selected for use in the present gel spinning process preferably has an intrinsic viscosity in decalin at 135° C. of at least about 15 dl/g, preferably greater than about 21 dl/g. The UHME PE polymer preferably has an intrinsic viscosity of from about 21 dl/g to about 100 dl/g, more preferably from about 21 dl/g to about 45 dl/g. As used herein, all referenced intrinsic viscosities (IV) are measured in decalin at 135° C. according to the techniques of ASTM D1601. Generally, a higher molecular weight polymer has a higher intrinsic viscosity and can form higher fiber tenacity than lower molecular weight polymers. Suitable UHMW PE polymers for use herein satisfying all of the above properties are commercially available.

The spinning solvent selected for use in the present gel spinning process comprises, consists of or consists essentially of trimethylbenzene, such that the compositions of this disclosure comprise, consist of or consist essentially of polyethylene and trimethylbenzene, with said compositions being a combination such as a mixture or solution of the polyethylene and trimethylbenzene, and the combination may be homogenous or non-homogenous. Trimethylbenzene is available in three isomeric forms: 1,2,3-trimethylbenzene, 1,2,4-trimethylbenzene and 1,3,5-trimethylbenzene. Each of these three forms is an acceptable solvent for polyethylene. Of these, 1,2,4-trimethylbenzene is most desirable for its optimal biocompatibility and in the preferred embodiments of this disclosure the spinning solvent comprises either a mixture of 1,2,4-trimethylbenzene with one or both of the other isomers, but most preferably the spinning solvent consists of or consists essentially of 1,2,4-trimethylbenzene. Each of these forms of trimethylbenzene is commercially available. Most preferably 100% of the spinning solvent consists of trimethylbenzene in one or more of said isomeric forms, but other non-trimethylbenzene solvent types may be present in trace amounts. In the event that trace amounts of non-trimethylbenzene solvent(s) are present, such would be less than 1% by weight of the total solvent weight.

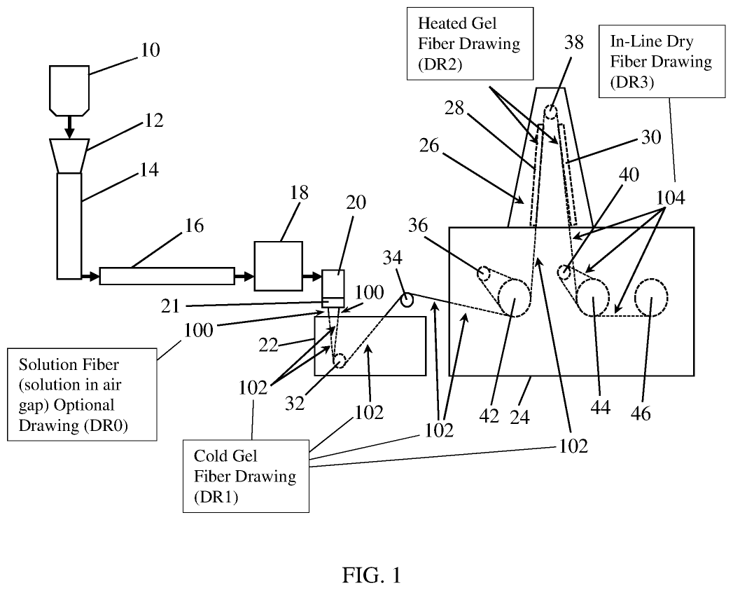

An exemplary process of forming the fibers of this disclosure is illustrated in FIG. 1. The components of the slurry can be provided in any suitable manner. For example, the slurry can be formed by combining the polyethylene polymer (e.g., UHME PE) and the spinning solvent in an agitated mixing tank 10, followed by providing the combined polymer and spinning solvent to a feed hopper 12, which then feeds the mixture into an extruder 14. The extruder 14 may or may not be heated. The polyethylene particles and solvent may be continuously fed to the mixing tank 10 with the slurry formed (or the slurry formation being initiated) within the tank 10, with it then being discharged to the hopper 12. The mixing tank 10 may optionally be heated and the slurry can be formed at a temperature that is below the temperature at which the polyethylene polymer will melt and thus also below the temperature at which the polyethylene will fully dissolve in the spinning solvent. For example, the slurry can be formed at room temperature or can be heated to a temperature of up to about 110° C. in the tank 10. The temperature and residence time of the slurry in the mixing tank are optionally such that the polyethylene particles will absorb at least 5 weight % of solvent at a temperature below that at which the polyethylene polymer will dissolve, as would be determined by one skilled in the art. Preferably, the slurry is at room temperature (20° C-22° C.) upon leaving the mixing tank. Alternately it may be heated to a temperature of from about 40° C. to about 140° C.

Several alternative modes of feeding the extruder 14 are contemplated. For example, a polyethylene-TMB slurry formed in a mixing tank 10 may be fed to the feed hopper 12 under no pressure, or alternatively the feed hopper 12 may be sealed and pressurized such that a slurry enters the sealed hopper 12 of the extruder 14 under a positive pressure at least about 20 KPa. The feed pressure enhances the conveying capacity of the extruder 14. However, most preferably no pressure is applied as the slurry is fed to the feed hopper 12. In an alternative embodiment, the slurry may be formed in the extruder 14. In this case, the polyethylene particles may be fed to an open feed hopper 12 and wherein the solvent is pumped directly into the extruder 14, e.g., at one or two barrel sections downstream in the extruder 14 rather than being added at the hopper 12. In yet another alternative feed mode, a concentrated slurry is formed in mixing tank 10, the concentrated slurry is then transferred to the hopper 12, and then a pure solvent stream pre-heated to a temperature above the polymer melting temperature is charged into the extruder 14, e.g., at one or more zones downstream in the extruder 14.

The extruder 14 to which the slurry is provided can be any suitable extruder, including for example a single screw extruder or a twin screw extruder, such as a non-intermeshing twin screw extruder or an intermeshing co-rotating twin screw extruder. Conventional devices, including but not limited to a Banbury Mixer, would also be suitable substitutes for a conventional extruder. Preferably, the extruder is an intermeshing co-rotating twin screw extruder, wherein the screw elements of the intermeshing co-rotating twin screw extruder are preferably forwarding conveying elements, preferably including no back-mixing or kneading segments.

Preferably, the slurry upon entering the extruder 14 is at a temperature below the melting point of the particular polyethylene polymer, and it is then preferably heated in the extruder 14 to a temperature at or above the melting point of the polyethylene polymer. Accordingly, a preferred gel spinning process of this disclosure includes extruding the slurry with the extruder 14 to form a mixture of melted polyethylene polymer (e.g., UHMW PE) and the spinning solvent inside the extruder 14, wherein the molten polyethylene at least partially mixes with the solvent within the extruder 14. The mixture of the polyethylene polymer and the spinning solvent that is formed in the extruder can thus be referred to as a liquid mixture of molten polyethylene polymer and the spinning solvent. The temperature at which the liquid mixture of molten polyethylene polymer and the spinning solvent is formed in the extruder can be from about 120° C. to about 165° C., preferably from about 125° C. to about 155° C., and more preferably from about 130° C. to about 145° C. Lower temperatures will minimize polymer degradation.

One example of a method for processing a polyethylene slurry through an extruder is described in commonly-owned U.S. Pat. No. 8,444,898, which describes processing the slurry through an extruder to form a liquid mixture of molten UHMW PE polymer and spinning solvent in the extruder, but the liquid mixture is quickly ejected from the extruder before the solution is fully formed. This patent particularly teaches that degradation of the polymer may be minimized by first forming the UHMW PE powder and solvent into a slurry in an extruder followed by processing that slurry through the extruder at a throughput rate of at least the quantity 2.0 D² grams per minute (g/min; wherein D represents the screw diameter of the extruder in centimeters) to thereby form a liquid mixture. That liquid mixture is then converted into a solution in a heated vessel, not in the extruder, whereby the heated vessel exerts very little, if any, shear stress on the mixture.

This is also preferred process of the present disclosure. The formation of a solution may be initiated in the extruder such that the polyethylene is at least partially dissolved in the trimethylbenzene solvent/solvent mixture while in the extruder, but the step of fully forming the liquid mixture into a solution where the polyethylene is fully dissolved in the trimethylbenzene solvent/solvent mixture, preferably forming a homogenous solution, takes place in a heated vessel located downstream from the extruder that exerts less stress on the mixture than the extruder. This reduces the polymer thermal and shear degradation which preserves the molecular weight of the polymer and allows for the fabrication of stronger fibers (or other articles). In this regard, “partially” dissolved means at least some of the polyethylene is dissolved in the solvent/solvent mixture, but not all, and includes from greater than 0% of the polyethylene by weight up to less than 100% by weight, and “fully” dissolved means that 100% of the polyethylene is dissolved in the solvent/solvent mixture. Preferably, from 0.1% by weight up to about 50% by weight of the polyethylene is dissolved while the mixture of the polyethylene and solvent is in the extruder, more preferably from 0.1% by weight up to about 33% by weight of the polyethylene is dissolved in the extruder, still more preferably from about 0.1% by weight to about 25% by weight of the polyethylene is dissolved in the extruder, and still more preferably from 0.1% by weight up to about 10% by weight of the polyethylene is dissolved in the extruder. Accordingly, in an exemplary composition of this disclosure in which the polyethylene is partially but not fully dissolved in a liquid solvent such as trimethylbenzene (e.g., 1,2,4-trimethylbenzene liquid solvent), the composition would comprise some dissolved polyethylene and some undissolved solid polyethylene. In this regard, such an exemplary composition with only partially dissolved polyethylene would include from 50% by weight up to about 99.9% by weight of solid polyethylene, more preferably from 67% by weight up to about 99.9% by weight of solid polyethylene, still more preferably from about 75% by weight to about 99.9% by weight of the polyethylene, and still more preferably from 90% by weight up to about 99.9% by weight of the polyethylene, with the remainder of the composition comprising dissolved polyethylene and optionally some solvent that is not yet mixed with the polyethylene.

With reference again to FIG. 1, once a liquid mixture is formed in extruder 14, the liquid mixture (and/or partially formed solution) is then promptly transferred into a heated vessel 16 where the remaining time needed for the solvent and polymer to completely diffuse into each other and form a uniform, homogenous solution is provided. Preferably, the average residence time of the mixture in the extruder is less than the residence time in the heated vessel, and most preferably the average residence time of the mixture in the extruder is less than half of the residence time of the mixture in the heated vessel. For example, the residence time of the liquid mixture in the extruder can be from about 1 minutes to about 60 minutes, preferably from about 3 minutes to about 30 minutes.

The liquid mixture of the polyethylene and the spinning solvent that exits the extruder can be passed via a pump, such as a positive displacement pump, into the heated vessel. It is preferred that the vessel is a heated pipe and it may be a straight length of pipe or it may have bends, or it may be a helical coil. It may comprise sections of differing length and diameter chosen so that the pressure drop through the pipe is not excessive. The polymer/solvent mixture entering the pipe is typically highly pseudoplastic and viscous, so it is preferred that the heated pipe contains one or more static mixers to redistribute the flow across the pipe cross-section at intervals, and/or to provide additional dispersion.

The heated vessel is preferably maintained at a temperature of at least about 130° C., preferably from about 130° C. to about 165° C., and most preferably from about 135° C. to about 155° C. The heated vessel can have a volume sufficient to provide an average residence time of the liquid mixture in the heated vessel to form a solution of the polyethylene polymer with the solvent. For example, the residence time of the liquid mixture in the heated vessel can be from about 2 minutes to about 120 minutes, preferably from about 6 minutes to about 60 minutes. In an alternative example, the placement and utilization of the heated vessel and the extruder can be reversed in forming the solution of polyethylene and spinning solvent. In such an example, a liquid mixture of polyethylene and spinning solvent can be formed in a heated vessel, and can then be passed through an extruder to form a solution that includes the polyethylene and the spinning solvent, or the polyethylene-solvent mixture may be transferred from the extruder to a second heated vessel to complete the formation of a homogenous solution.

Each of the slurry, liquid mixture and solution can include polyethylene in an amount (concentration) of from about 1% by weight to about 50% by weight of the solution, preferably from about 1% by weight to about 30% by weight of the solution, more preferably from about 2% by weight to about 20% by weight of the solution, and even more preferably from about 3% by weight to about 10% by weight of the solution. In the most preferred embodiments where the solution is to be spun into filaments, the solution includes polyethylene (preferably UHMW PE) in an amount of 6.5% or less by weight of the solution (i.e. the weight of the solvent plus the weight of the dissolved polymer), or more particularly 5.0% or less by weight of the solution, or even more preferably 4.0% or less by weight of the solution. Most preferably, the solution includes polyethylene in an amount of from greater than 3% by weight to less than 6.5% by weight of the solution, or more particularly from greater than 3% by weight to less than 5% by weight based on the weight of the polyethylene polymer plus the weight of the solvent.

After the solution is formed, processing the solution into filaments conventionally includes the following steps:

4) Passing the thus-formed solution through a spinneret to form solution filaments;

5) Passing said solution filaments through a short gaseous space into a liquid quench bath wherein said solution filaments are rapidly cooled to form gel filaments;

6) Removing the solvent from the gel filaments to form solid filaments; and

7) Stretching at least one of the solution filaments, the gel filaments and the solid filaments in one or more stages.

As illustrated in FIG. 1, a removable spinneret 21 is attached to a spin block 20. The spin block 20 evenly distributes the polyethylene-TMB solution to the spinneret 21. The process of providing the solution of the polyethylene polymer and spinning solvent from the heated vessel 16 to the spinneret 21 can include passing the solution through a metering pump 18, which can be a gear pump. When the solution is passed through the spinneret it is extruded into a plurality of solution filaments 100, as is conventionally known in the art, and which may also be referred to as a multi-filament solution fiber. The spinneret can form solution fibers having any suitable number of filaments depending on the number of spinholes the spinneret includes. In one example, the spinneret can have from about 2 spinholes to about 3000 spinholes, so the solution fiber will comprise from about 2 filaments to about 3000 filaments. Preferably, the spinneret can have from about 6 spinholes to about 500 spinholes and the solution fiber includes can comprise from about 6 filaments to about 500 filaments. The spinholes can have a conical entry, with the cone having an included angle from about 15 degrees to about 75 degrees. Preferably, the included angle is from about 30 degrees to about 60 degrees. Additionally, following the conical entry, the spinholes can have a straight bore capillary extending to the exit of the spinhole. The capillary can have a length to diameter ratio of from about 10 to about 100, more preferably from about 15 to about 40.

Once the solution filaments 100 are issued from the spinneret 21 they are passed into a liquid quench bath that is held in a quench tank 22, and they are rapidly cooled in the bath to form gel filaments 102. The liquid in the quench bath is preferably selected from the group consisting of water, ethylene glycol, ethanol, isopropanol, a water soluble anti-freeze and their mixtures. Preferably, the liquid quench bath temperature is from about −35° C. to about 35° C. There is a small gaseous space (i.e., a gap) between the end of the spinneret and the quench bath and as the solution filaments pass through this gaseous space they are vulnerable to oxidation if the space contains oxygen, such as if the space is filled with air. Oxidation of the solution filaments can degrade the molecular weight of the polymer and thereby degrade the fiber tensile properties, so to minimize polymer degradation it is known to fill the gaseous space with nitrogen or another inert gas like argon. Limitation of the length gaseous space will also minimize the potential for oxidation, particularly if filling the gap with an inert gas is impractical. The length of the gaseous space between the spinneret and the surface of the liquid quench bath is preferably from about 1.0 mm to about 100 mm, more preferably from about 3.0 mm to about 30 mm. If the residence time of the solution yarn in the gaseous space is less than about 1 second, the gaseous space may be filled with air, otherwise filling the space with an inert gas is most preferred.

Once the solution filaments 100 are cooled and transformed into gel filaments 102, the trimethylbenzene spinning solvent (or solvent mixture) must be removed from the gel filaments 102. At this stage, the gel filaments contain at least 1% of the solvent by weight of the fiber and up to about 96% of the solvent by weight of the fiber. As such, a gel composition is a polymer composition that still includes at least 1% by weight of solvent based on the weight of the solvent plus the weight of the polymer. Removal of the trimethylbenzene is accomplished by drying, i.e., by evaporation, according to techniques that are well known in the art. Since it is a volatile solvent, there is no need to extract it with a second solvent as is necessary with non-volatile solvents. Each of the three trimethylbenzene isomers has an atmospheric boiling point of from about 165° C. to 176° C. (1,2,3-TMB: 176° C.; 1,2,4-TMB: 169° C.; 1,3,5-TMB: 165° C.), which are higher than the melting point of ultra-high molecular weight polyethylene, which is approximately 130° C. to 136° C., so it is preferred to evaporate the solvent at a temperature below 130° C., preferably at a temperature below 100° C., or even at ambient room temperature (i.e., from about 20° C. to 22° C.). Drying of the gel filaments 102 may be accomplished by passing them into a chamber 26 (e.g., an oven) that is heated to the desired temperature, which would be a temperature high enough to evaporate the solvent in a reasonable time (as determined by one skilled in the art) but not high enough to cause the filaments to become fuse together during drying, with the optimum drying temperature being the highest temperature that does not cause fusing of the filaments during drying. This temperature depends on the solvent concentration in the gel fiber along with the fiber speed and tension during drying. Alternatively, chamber 26 may contain hot plates 28 and 30 over which the gel filaments are passed to induce evaporation of the solvent. Hot plates 28 and 30 may be heated to any desired temperature and this method of drying fibers is conventionally known in the art. Whether drying is performed in an oven or with the hot plates, the drying temperature is typically from about 50° C. to about 100° C. Most preferably, the drying temperature increases along the length of the drying path from about 60° C. up to about 90° C.

Removal of all or mostly all of the solvent thereby forms a dry fiber 104. A partially dry fiber may include residual solvent in an amount that is less than about 5 percent by weight based on the weight of the fiber plus any residual solvent, preferably less than about 2 weight percent based on the weight of the fiber plus any residual solvent, but the dry fiber after the solvent evaporation process concludes will include less than about 1 weight percent of solvent based on the weight of the fiber plus the weight of any residual solvent.

As illustrated in FIG. 1, the gel spinning process can include drawing (stretching) the solution filaments 100 (solution fiber) that issue from the spinneret 21, the gel filaments 102 (gel fiber) that are formed in the quench bath, and the solid, dry fiber 104 that results from the evaporation of the spinning solvent. Fiber drawing is conventionally known in the art and is accomplished, for example, by passing the fiber at its various stages over rolls. In the embodiment illustrated in FIG. 1, the process includes unheated, undriven guide rolls 32, 34, 36, 38 and 40; unheated, driven draw rolls 42 and 44, and a final driven winding roll 46, but this set-up is merely exemplary and may be adjusted or customized by one skilled in the art to include more or fewer rolls. For example, the fiber can be wound onto a beam, or one or more core tubes rather than a roll. Winding of the fiber can also be accomplished without or without twist being imparted to the fiber. It should be noted that the rolls illustrated in FIG. 1 are also not necessarily drawn to scale.

With reference to FIG. 1, the solution filaments 100 that issue from the spinneret 21 and which are quenched into gel filaments 102 are optionally drawn as gel filaments 102. These gel filaments 102 are passed over a first guide roll 32 that is located within quench tank 22 and then from guide roll 32 the gel filaments 102 are then passed over a second guide roll 34 that is located outside the quench tank 22. From there the gel filaments 102 are transferred to a draw bench 24 that houses additional guide rolls 36 and 40 as well as first draw roll 42 and second draw roll 44. In the embodiment of FIG. 1, the gel filaments 102 are passed around the first draw roll 42 a first time, then around guide roll 36, then back around first draw roll 42 a second time, up and around guide roll 38, then around second draw roll 44 a first time, then around guide roll 40, then around second draw roll 44 a second time, and finally it is wound up on driven winding roll 46. In this process, as illustrated in FIG. 1, in between draw rolls 42 and 44 the fiber is passed into contact drying zone 26 which may be a heated oven or may contain hot plates 28 and 30 over which the gel filaments are passed to induce evaporation of the solvent, as discussed above. Whether the drying zone 26 includes hot plates 28 and 30 or is an oven heated by other means, the gel fiber 102 is heated to any desired temperature below the melting temperature of the polyethylene polymer. These methods of drying fibers (oven or hot plate drying techniques) are conventionally known in the art. The drying process may also include a means for exhausting the evaporated solvent (not illustrated in FIG. 1) from the atmosphere for disposal (e.g., in a thermal oxidizer) or for recycling (e.g., by condensing the evaporated solvent back into a liquid for reuse). Means of exhausting the evaporated solvent from the atmosphere could include an exhaust fan, with piping between the fiber drying enclosure and the fan, and additional piping after the fan for solvent vapor delivery to disposal or recycling equipment. At the completion of the drying process, the solvent is preferably fully removed to achieve dry, fully solvent-free filaments, i.e., a dry, fully solvent-free fiber. In other embodiments, some residual solvent may remain in the fiber, but such residual solvent will still be very low, i.e., less than 1% by weight of the fiber, more preferably less than 0.5% by weight of the fiber, or less than 0.25% of the weight of the fiber or less than 0.1% of the weight of the fiber, whereas the non-fully dried gel fiber will include greater than 1% solvent by weight of the polyethylene plus the weight of the solvent.

In a typical gel spinning process, a polyethylene fiber is drawn in each of the solution fiber state, gel fiber state and dry fiber state. The solution fiber 100 is drawn because of the tension exerted on the spun filaments as they are continuously produced and wound as a continuous strand onto draw roll 42 toward driven winding roll 46. In the preferred embodiments of this disclosure, the solution fiber 100 that issues from the spinneret is drawn at a draw ratio of from about 1.1:1 to about 30:1 to form a drawn solution fiber. Stretching of the solution fiber within the gaseous space between the spinneret and the liquid quench bath is influenced by the length of the gaseous space. A longer space may lead to greater stretching of the solution filaments inside the space, so this variable may be controlled as desired if more or less stretching of the solution filaments is desired.

In the preferred embodiments, the gel fiber 102 is drawn in one or more stages at a first draw ratio DR1 of from about 1.1:1 to about 30:1. Drawing the gel fiber 102 in one or more stages at the first draw ratio DR1 can be accomplished by passing the gel fiber through a set of rolls (rollers), such as guide roll 36 and draw roll 42, as illustrated in

FIG. 1. Preferably, drawing the gel fiber 102 at the first draw ratio DR1 can be conducted without applying heat to the fiber, and can be conducted at a temperature less than or equal to about 2° C. Drawing the gel fiber 102 can also include drawing the gel fiber 102 at a second draw ratio DR2. Drawing the gel fiber 102 at the second draw ratio DR2 can also include simultaneously removing at least a portion of the spinning solvent from the gel fiber 102, such as in the chamber 26 or by passing the fiber along hot plates 28 and/or 30 to form the dry fiber 104. Accordingly, the second drawing step DR2 may be conducted in the chamber 26, in the draw bench 24, or in both the chamber 26 and draw bench 24. Preferably, the gel fiber 102 is drawn at a second draw ratio DR2 of about 1.5:1 to about 10:1, more preferably at about 2:1 to about 8:1, and most preferably at about a 3:1 to about 6:1 draw ratio.

The gel spinning process can also include drawing the dry fiber 104 at a third draw ratio DR3 in at least one stage. Drawing the dry fiber 104 at the third draw ratio can be accomplished, for example, by passing the dry fiber 104 through draw bench 24. The third draw ratio can be from about 1.1:1 to about 3.0:1, more preferably is less than about 1.5:1, still more preferably is from about 1.1:1 to about 1.5:1.

As illustrated in FIG. 1, drawing the gel fiber 102 and the dry fiber 104 at draw ratios DR1, DR2 and DR3 can be done in-line. In one example, the combined draw of the gel fiber 102 and the dry fiber 104, which can be determined by multiplying DR1, DR2 and DR3 (DR1×DR×DR3:1 or (DR1)(DR2)(DR3):1), the combined draw ratio of DR1×DR2×DR3:1 can be at least about 5:1, preferably at least about 10:1, more preferably at least about 15:1, and most preferably is at least about 20:1. Preferably, the dry fiber 104 is maximally drawn in-line until the last stage of draw is at a draw ratio of less than about 1.2:1. Optionally, the last stage of in-line drawing of the dry fiber 104 can be followed by relaxing the fiber at from about 0.5 percent of its length to about 5 percent of its length.

Preferably, stretching is performed on all three of the solution fiber 100 (solution filaments), the gel fiber 102 (gel filaments) and the solid, dry fiber 104 (solid, dry filaments). During the processing of the fibers, stretching is performed on at least one of the solution fiber 100, the gel fiber 102 and the solid fiber 104 in one or more stages to a combined stretch ratio (draw ratio) of at least about 10:1, wherein an in-line stretch of less than 1.5:1 is preferably applied to the solid fiber 104 to form a high strength multi-filament polyethylene fiber. Additional post-drawing operations, including further drawing of the dry fiber 104 may be conducted as described in commonly-owned U.S. Pat. Nos. 6,969,553; 7,370,395; 7,344,668; 8,361,366; 8,444,898; or 8,747,715, each of which is incorporated herein by reference to the extent compatible herewith.

As used herein, the terms “drawn” filaments/fibers or “drawing” filaments/fibers are known in the art, and are also known in the art as “oriented” or “orienting” filaments/fibers or “stretched” or “stretching” filaments/fibers. These terms are used interchangeably herein. Also, as used herein, the term “draw ratio” refers to the ratio of the speeds of the draw rolls used during the orientation process. Stretching of solid filaments/fibers most commonly includes a post-drawing operation to increase final yarn tenacity. See, for example, the commonly-owned U.S. patents referenced in the previous paragraph, which describe post-drawing operations that are conducted on partially oriented yarns/fibers to form highly oriented yarns/fibers of higher tenacities. Such post-drawing is performed off-line as a decoupled process using separate stretching equipment.

In an exemplary post-drawing process, the dry fibers that are wound onto the driven winding roll 46 may be unwound from the driven winding roll 46 and drawn again, i.e., post-drawn, in accordance with the process disclosed in U.S. Pat. No. 9,365,953 (which is incorporated herein by reference) to a fourth draw ratio DR4 (off-line and not illustrated in FIG. 1) of from about 1.1:1 to about 15:1. In a preferred embodiment, the post-drawing draw ratio DR4 is from about 1.1:1 to about 9:1, or from about 1.5:1 to about 6.0:1, or from about 2.5:1 to about 5.5:1. Alternatively, a second post-drawing may be conducted at a draw ratio of from about 1.1:1 to 1.7:1, or from about 1.1:1 to 1.6:1, or from 1.1:1 to 1.5:1, or from about 1.1:1 to about 1.4:1, or from 1.1:1 to 1.3:1, or from 1.1:1 to 1.2:1, preferably thereby forming a highly oriented fiber product having a tenacity of at least about 30 g/denier, or about 35 g/denier or greater, or about 40 g/denier or greater, or about 45 g/denier or greater.

The primary purpose of drawing the fibers, including the above-described post-drawing process, is to increase their tensile strength, and thereby forming high tensile strength fibers. As used herein, a “high tensile strength” fiber is one which has a tenacity of at least 10 g/denier, an initial tensile modulus of at least about 150 g/denier or more, and an energy-to-break of at least about 8 J/g or more, each as measured by ASTM D2256. In this regard, the term “tenacity” refers to the tensile stress expressed as force (grams) per unit linear density (denier) of an unstressed specimen. The term “initial tensile modulus” refers to the ratio of the change in tenacity, expressed in grams-force per denier (g/d) to the change in strain, expressed as a fraction of the original fiber/tape length (in/in).

The high tensile strength dry fibers of this disclosure preferably have a tenacity of greater than 10 g/denier, more preferably at least about 15 g/denier, still more preferably at least about 20 g/denier, still more preferably at least about 27 g/denier, more preferably a tenacity of from about 28 g/denier to about 60 g/denier, still more preferably from about 33 g/denier to about 60 g/denier, still more preferably 39 g/denier or more, still more preferably from at least 39 g/denier to about 60 g/denier, still more preferably 40 g/denier or more, still more preferably 43 g/denier or more, or at least 43.5 g/denier, still more preferably from about 45 g/denier to about 60 g/denier, still more preferably at least 45 g/denier, at least about 48 g/denier, at least about 50 g/denier, at least about 55 g/denier or at least about 60 g/denier.

As is conventionally known, drawing/stretching of the fibers also affects the denier of the resulting drawn fibers. As used herein, the term “denier” refers to the unit of linear density equal to the mass in grams per 9000 meters of filament/fiber. Fiber denier is determined by both the linear density of each filament forming the fiber, i.e. denier per filament (dpf), and the number of filaments forming the fiber. Generally, once all stretching steps have been completed, fibers of this disclosure will have a denier per filament of from about 0.1 to about 10.0, more preferably from about 0.5 to about 2.5, and still more preferably from about 0.75 to about 1.5 dpf. While these low dpf ranges are preferred for medical applications, broader ranges may be useful for other applications. For example, the fiber denier per filament may range from 1.4 dpf to about 15 dpf, or from about 2.2 dpf to about 15 dpf, or from about 2.5 dpf to about 15 dpf. However, other filament deniers are useful including from about 3 dpf to about 15 dpf, about 4 dpf to about 15 dpf, or about 5 dpf to about 15 dpf.

The total denier of a multifilament fiber of this disclosure depends on the total number of filaments forming the fiber. In the preferred embodiments, multifilament fibers of this disclosure preferably include from 2 to about 1000 filaments, more preferably from 2 to 500 filaments, still more preferably from 4 to 500 filaments, more preferably from about 6 to 500 filaments and most preferably from about 6 filaments to about 250 filaments. Resulting multi-filament fibers having the above recited dpf ranges for the component filaments will preferably have a total fiber denier ranging from about 2 to about 1000 denier, more preferably from about 2 to about 500 denier, still more preferably from about 3 to about 500 denier, still more preferably from about 4 to about 500 denier, and most preferably from about 5 to about 250 denier.

The fibers described herein are particularly useful for the fabrication of sutures to be used in the bodies of humans and animals, i.e., in vivo. Exemplary applications are cardiovascular and orthopedic sutures, as well as stents and catheters, or even dental floss. In medical applications, it is known that colorants are sometimes added to polyethylene fibers to allow visual fiber identification during surgery. The compositions of this disclosure which are made from a solvent or solvent mixture that is removed only by evaporation and without requiring solvent extraction with a second solvent, is also optimal for colorant use to form colored fibers.

Further, in order to ensure their suitability for use in vivo, it is important that the fibers not be coated with any lubricants or spin finishes during the manufacturing process. The application of a spin finish during gel spinning is typical in order to avoid static buildup and tangling of the fibers during their manufacture, so these are normally expected problems if a finish is not applied and therefore adjustments to the processing steps are necessary. In the preferred embodiments of this disclosure, fibers can be manufactured without the application of any lubricants or spin finishes by limiting fiber speed by minimizing in-line drawing of the dry fiber during the spinning process, maintaining a relatively high tension of at least about 1 g/denier up to 10 g/denier on the dry fiber during the spinning process, and by avoiding low humidity conditions during spinning by controlling the humidity inside the room or inside the equipment where the drawing is being performed, such as by applying a water mist or steam around the dry fiber after the solvent has been removed. The application of a cool water mist or steam to the fibers is conducted according to conventional methods in the art, such as by misting with fogging nozzles using only water pressure or by atomizing nozzles that use pressurized air (or another gas, e.g., an inert gas such as helium or argon) to produce a water mist, or by injecting steam in to enclosures through which the fiber passes during processing. Methods of generating said steam are well known. Twisting the fiber before post-drawing will also limit static-related problems when the fiber is to be post-drawn, such as discussed above. Various methods of twisting fibers are known in the art and any method may be utilized. Useful twisting methods are described, for example, in U.S. Pat. Nos. 2,961,010; 3,434,275; 4,123,893; 4,819,458 and 7,127,879, the disclosures of which are incorporated herein by reference to the extent consistent herewith. In a preferred embodiment, the fibers are twisted to have an angle relative to the twisted bundle axis of 5° up to about 40° , more preferably from about 5° to about 30° and most preferably from about 15° up to about 30° . The standard method for determining twist in twisted fibers is ASTM D1423.

In an alternate embodiment of this disclosure, it may be desirable to convert the gel spun multifilament fibers into the form of fibrous tapes, such as described in, for example, commonly-owned U.S. Pat. Nos. 8,263,119; 8,697,220; 8,685,519; 8,852,714; 8,906,485; 9,138,961 and 9,291,440, each of which is incorporated herein by reference to the extent consistent herewith, which teach processes wherein a multifilament fiber is compressed and flattened. In this regard, the term “tape” refers to a flat, narrow, monolithic strip of material having a length greater than its width and an average cross-sectional aspect ratio (i.e., the ratio of the greatest to the smallest dimension of cross-sections averaged over the length of the tape) of at least about 3:1. Such tapes preferably have a substantially rectangular cross-section with a thickness of about 0.5 mm or less, more preferably about 0.25 mm or less, still more preferably about 0.1 mm or less and still more preferably about 0.05 mm or less. In the most preferred embodiments, the tapes have a thickness of up to about 3 mils (76.2 μm), more preferably from about 0.35 mil (8.89 μm) to about 3 mils (76.2 μm), and most preferably from about 0.35 mil to about 1.5 mils (38.1 μm). Thickness is measured at the thickest region of the cross-section. Tapes formed in accordance with this disclosure have preferred widths of from about 2.5 mm to about 50 mm, more preferably from about 5 mm to about 25.4 mm, even more preferably from about 5 mm to about 20 mm, and most preferably from about 5 mm to about 10 mm. These dimensions may vary but the tapes are most preferably fabricated to have dimensions that achieve an average cross-sectional aspect ratio of greater than about 3:1, more preferably at least about 5:1, still more preferably at least about 10:1, still more preferably at least about 20:1, still more preferably at least about 50:1, still more preferably at least about 100:1, still more preferably at least about 250:1 and most preferably an average cross-sectional aspect ratio of at least about 400:1, or an aspect ratio of from about 3:1 to about 400:1.

A fibrous tape comprises one or more filaments. Like fibers, the fibrous tapes may be of any suitable denier, preferably having a denier of from about 5 to about 5000, more preferably from about 10 to 2000 denier, still more preferably from about 15 to about 500 denier, and most preferably from about 20 to about 200 denier. Additionally, tapes formed from the compositions of this disclosure are preferably “high tensile strength” tapes having a tenacity of at least 10 g/denier, an initial tensile modulus of at least about 150 g/denier or more, and an energy-to-break of at least about 8 J/g or more, each as measured by ASTM D882-09 at 10 inch (25.4 cm) gauge length and at an extension rate of 100%/min. The high tensile strength tapes preferably have a tenacity of greater than 10 g/denier, more preferably at least about 15 g/denier, still more preferably at least about 20 g/denier, still more preferably at least about 27 g/denier, more preferably a tenacity of from about 28 g/denier to about 60 g/denier, still more preferably from about 33 g/denier to about 60 g/denier, still more preferably 39 g/denier or more, still more preferably from at least 39 g/denier to about 60 g/denier, still more preferably 40 g/denier or more, still more preferably 43 g/denier or more, or at least 43.5 g/denier, still more preferably from about 45 g/denier to about 60 g/denier, still more preferably at least 45 g/denier, at least about 48 g/denier, at least about 50 g/denier, at least about 55 g/denier or at least about 60 g/denier, each as measured by ASTM D882-09 at 10 inch (25.4 cm) gauge length and at an extension rate of 100%/min.

It has also been unexpectedly found that the polyethylene-trimethylbenzene compositions produced in accordance with this disclosure may be utilized in other non-medical end use applications, such as hollow braids, fabrics, robotic cables, composites and other applications such as those of the commonly-owned references incorporated by reference herein. In one alternative application, a composition comprising a mixture of polyethylene and trimethylbenzene may be applied onto a surface or onto a substrate, using conventional methods, to form a film or a coatings having high strength and toughness, or the composition may be extruded or otherwise formed into other (non-fiber) shapes or articles by conventional methods such as extrusion or molding. In such embodiments, the compositions may be formed from a polyethylene-trimethylbenzene slurry and converted into a liquid mixture and solution as discussed above for the gel spinning process, followed by forming solutions into other shapes or articles, and such polyethylene-trimethylbenzene solutions likewise can include polyethylene in an amount of from about 1% by weight to about 50% by weight of the solution, preferably from about 1% by weight to about 30% by weight of the solution, more preferably from about 2% by weight to about 20% by weight of the solution, and even more preferably from about 3% by weight to about 10% by weight of the solution. The polyethylene-trimethylbenzene compositions may further be heated to evaporate most or all of the trimethylbenzene solvent to form a dry solid, or the solvent/solvent mixture may simply be allowed to dry under ambient conditions. In these non-fiber embodiments, the polyethylene-TMB compositions may retain a greater quantity of the residual solvent in the final products, e.g., about 1.0% to about 5.0% based on the total weight of the composition, and may contain other additives as may be desired, e.g., one or more colorants such as pigments or dyes.

In yet another alternate embodiment, the polyethylene-trimethylbenzene compositions may be extruded into non-fibrous tapes which may be formed, for example, from strips of polymer formed by slicing a polymer film, or any other method such as those described in U.S. Pat. Nos. 9,138,961 and 9,291,440. Such tapes will have the same dimensions and deniers as the aforementioned fibrous tapes but are not formed by compressing spun fibers/filaments and do not comprise gel spun filaments, and they may or may not contain a residual solvent.

The following non-limiting examples serve to illustrate the preferred embodiments of the disclosure:

### EXAMPLE 1

A slurry consisting of 6 wt.% of an UHMW PE and 94 wt.% of TMB was prepared in an agitated mix tank at room temperature (22° C.). The UHMW PE was a linear polyethylene having an intrinsic viscosity of 20 dl/g in decalin at 135° C. The linear polyethylene had fewer than about 0.5 substituents per 1000 carbon atoms and a melting point of 138° C. The TMB was 1,2,4-trimethylbenzene, 98% grade.

The slurry was fed into the feed hopper of a conical intermeshing twin screw extruder having a screw diameter varying from 25.6 mm at its inlet to 9.2 mm at its discharge end.

The screw flights were all forwarding conveying. The free volume in this extruder (barrel volume minus screw volume) was 15 cm³. The extruder barrel was heated in three equal-length sequential zones, with temperatures of 130° C., 150° C. and 160° C. The screw rotational speed was 150 revolutions per minute (RPM). The UHMW PE/TMB slurry was converted to a liquid mixture at 150° C. in passing through the extruder with an average throughput rate of 0.67 g/min.

The liquid mixture leaving the extruder was then passed through another vessel consisting of an externally heated pipe, heated at a temperature of 150° C., and having an internal volume of 25.8 cm³. The liquid mixture was converted to a solution in passing through this vessel with an average residence time of 27.9 minutes.

The UHMW PE solution leaving the pipe vessel was passed through a gear pump and thence through a spin block, with a multi-hole spinneret mounted on the spin block, with the spinneret having 6 holes of 1 mm diameter, to thereby form 6-filament solution fiber. The solution fiber was then stretched at a draw ratio (DR0) of 5.86:1 in passing through a 0.5-inch air gap into a water bath where it was quenched to form a gel fiber. The gel fiber was then stretched at a draw ratio (DR1) of 3.25:1 at room temperature (22° C.) without heating.

The TMB was then evaporated from the gel fiber by passage over heated plates. Some stretching of the fiber occurred during drying, with the fiber being stretched at a draw ratio (DR2) of 4.57:1 during drying at an average temperature of 75° C., but there was no measurable in-line drawing of the dried fiber (i.e., no measurable DR3). The dried fiber was then wound up on an unheated winding roll. The dried UHMW PE fiber had a denier of 25.9.

The dried fiber was then stretched in an off-line post-draw operation at a draw ratio (DR4) of 2.88:1 over heated plates at an average temperature of 131° C. The final post-drawn 6-filament UHMW PE fiber had a denier of 9 (1.50 denier per filament (dpf)) and a tenacity of 33.5 g/d. The data for this example are summarized in Tables I and II below.

### EXAMPLE 2

A solution of UHMW PE and 1,2,4-TMB were formed as in Example 1 and the solution was formed into a 6-filament solution fiber also as in Example 1. The solution fiber was then stretched at a draw ratio (DRO) of 8.88:1 in passing through a 0.38-inch air gap to a water bath where it was quenched to form a gel fiber. The gel fiber was then stretched at a draw ratio (DR1) of 4.29:1 at room temperature (22° C.) without heating.

The TMB was then evaporated from the gel fiber by passage over heated plates. Some stretching of the fiber occurred during drying, with the fiber being stretched at a draw ratio (DR2) of 4.14:1 during drying at an average temperature of 75° C., but there was no measurable in-line drawing of the dried fiber (i.e., no measurable DR3). The dried fiber was then wound up on an unheated winding roll. The dried UHMW PE fiber had a denier of 14.5.

The dried fiber was then stretched in an off-line post-draw operation at a draw ratio (DR4) of 3.09:1 over heated plates at an average temperature of 131° C. The final post-drawn 6-filament UHMW PE fiber had a denier of 4.7 (0.78 dpf) and a tenacity of 40.2 g/d. The data for this example are summarized in Tables I and II below.

### EXAMPLE 3

A solution of UHMW PE and 1,2,4-TMB were formed as in Example 1 and the solution was formed into a 6-filament solution fiber also as in Example 1. The solution fiber was then stretched at a draw ratio (DR0) of 8.88:1 in passing through a 0.38-inch air gap to a water bath where it was quenched to form a gel fiber, as in Example 2. The gel fiber was then stretched at a draw ratio (DR1) of 4.29:1 at room temperature (22° C.) without heating, also as in Example 2. The TMB was then evaporated from the gel fiber by passage over heated plates with some stretching of the fiber occurring during drying. The fiber was stretched at a draw ratio (DR2) of 4.14:1 during drying at an average temperature of 75° C., but there was no measurable in-line drawing of the dried fiber (i.e., no measurable DR3), also as in Example 2. The dried fiber was then wound up on an unheated winding roll wherein the dried UHMW PE fiber had a denier of 14.5 as in Example 2. The dried fiber was then stretched in an off-line post-draw operation at a draw ratio (DR4) of 4.14:1 over heated plates at an average of temperature of 131° C. The final post-drawn 6-filament UHMW PE fiber had a denier of 3.5 (0.58 dpf) and had a tenacity of 42.6 g/d. The data for this example are summarized in Tables I and II below.

TABLE I

| | | Solution | Unheated | Heated | | In-Line |
|---|---|---|---|---|---|---|
| | | Fiber | Gel Fiber | Gel Fiber | | Dry Fiber |
| | Spinning | Draw | Draw | Draw | Dried | Draw |
| | Air Gap | Ratio | Ratio | Ratio | Fiber | Ratio |
| Ex. | (inch) | (DR0) | (DR1) | (DR2) | Denier | (DR3) |
| 1 | 0.50 | 5.86 | 3.25 | 4.57 | 25.9 | N/A |
| 2 | 0.38 | 8.88 | 4.29 | 4.14 | 14.5 | N/A |
| 3 | 0.38 | 8.88 | 4.29 | 4.14 | 14.5 | N/A |

TABLE II

| | Off- Line | | Post- | |
|---|---|---|---|---|
| | Dry Fiber | Post- | Drawn | Post-Drawn |
| | Draw Ratio | Drawn | Fiber | Fiber |
| | (Post-Draw) | Fiber | Tenacity | Modulus |
| Ex. | (DR4) | Denier | (g/d) | (g/d) |
| 1 | 2.88 | 9.0 | 33.5 | 1,003 |
| 2 | 3.09 | 4.7 | 40.2 | 1,131 |
| 3 | 4.14 | 3.5 | 42.6 | 1,393 |

While the present disclosure has been particularly shown and described with reference to preferred embodiments, it will be readily appreciated by those of ordinary skill in the art that various changes and modifications may be made without departing from the spirit and scope of the disclosure. It is intended that the claims be interpreted to cover the disclosed embodiment, those alternatives which have been discussed above and all equivalents thereto.

What is claimed is:

1. A composition comprising a mixture of polyethylene and trimethylbenzene.

2. The composition of claim 1 wherein the trimethylbenzene is a liquid solvent and wherein the polyethylene is at least partially dissolved in said trimethylbenzene.

3. The composition of claim 2 wherein said composition is a solution wherein the polyethylene is fully dissolved in said trimethylbenzene solvent.

4. The composition of claim 2 wherein said composition comprises at least one additional liquid solvent.

5. The composition of claim 2 wherein said trimethylbenzene comprises 1,2,4-trimethylbenzene.

6. The composition of claim 5 wherein said composition is a dry solid.

7. The composition of claim 6 wherein said trimethylbenzene comprises 1,2,4-trimethylbenzene.

8. The composition of claim 7 wherein said composition comprises a monofilament or multifilament fiber.

9. The composition of claim 1 wherein said composition is a gel comprising greater than 1% solvent by weight based on the weight of the polyethylene plus the weight of the solvent.

10. The composition of claim 1 wherein said polyethylene comprises ultra-high molecular weight polyethylene and wherein said trimethylbenzene comprises 1,2,4-trimethylbenzene.

11. A fiber formed from the composition of claim 10.

12. The fiber of claim 11 wherein said fiber comprises a multi-filament fiber having a denier per filament of less than 5.

13. The fiber of claim 11 wherein said fiber is free of any spin finish.

14. The fiber of claim 11 wherein said fiber consists of said ultra-high molecular weight polyethylene and said 1,2,4-trimethylbenzene.

15. A process for preparing a polyethylene fiber product comprising:
a) forming a solution of polyethylene in a trimethylbenzene solvent, wherein said polyethylene has a weight average molecular weight of at least 500,000 g/mol;
b) spinning the solution through a spinneret to form one or more solution filaments;
c) cooling the solution filaments wherein said one or more solution filaments are converted into gel filaments, wherein said gel filaments comprise greater than 1% solvent by weight of the polyethylene plus the solvent; and
d) evaporating the solvent from the gel filaments to form dried filaments, wherein the evaporation continues until the solvent concentration in the dried filament is less than 1% by weight of the polyethylene plus the solvent.

16. The process of claim 15 wherein the solution is spun into a plurality of solution filaments in step b), wherein the polyethylene fiber product is a multifilament fiber.

17. The composition of claim 16 wherein said trimethylbenzene comprises 1,2,4-trimethylbenzene.

18. The process of claim 17 further comprising stretching at least one of the solution filaments, the gel filaments and the dried filaments, and wherein the dried filaments are thereafter packaged without being coated with a surface finish.

19. The process of claim 17 further comprising stretching at least one of the solution filaments, the gel filaments and the dried filaments to a stretch ratio of at least 10:1 to produce a multifilament fiber having a denier of less than 5.

20. The process of claim 17 wherein at least the dried filaments are drawn, wherein the dried filaments are twisted prior to being drawn and wherein the dried filaments are thereafter packaged without being coated with a surface finish.
